(19) United States
(12) Patent Application Publication
(10) Pub. No.: US 2007/0159557 A1
(43) Pub. Date: Jul. 12, 2007

(54) SEMICONDUCTOR INTEGRATED CIRCUIT

(75) Inventors: Masato Nakakita, Osaka (JP); Makoto Yamamoto, Osaka (JP); Toshinobu Nagasawa, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Osaka (JP)

(21) Appl. No.: 11/617,362

(22) Filed: Dec. 28, 2006

(30) Foreign Application Priority Data
Jan. 12, 2006 (JP) JP2006-005089

(51) Int. Cl. H04N 5/14

(52) U.S. Cl. 348/707

(57) ABSTRACT

A semiconductor integrated circuit includes an audio signal amplifier and a video signal amplifier built in a single semiconductor chip, the audio signal amplifier and the video signal amplifier being configured to receive a supply of a positive power supply voltage and a negative power supply voltage. The semiconductor integrated circuit further includes a negative voltage generation circuit that generates the negative power supply voltage and supplies the negative power supply voltage to the audio signal amplifier and the video signal amplifier and a limit circuit that limits an amplitude of a signal input to the audio signal amplifier to a range free from an influence of a fluctuation in the negative power supply voltage supplied by the negative voltage generation circuit. Adverse effects on an audio signal due to a fluctuation of a negative voltage occurring in synchronization with the vertical period of a video signal can be suppressed with a simple additional circuit.

### BACKGROUND OF THE INVENTION

1. Field of the Invention

The present invention relates to a semiconductor integrated circuit for portable AV equipment including an audio signal amplifier and a video signal amplifier.

2. Description of Related Art

In portable AV equipment handling video signals and audio signals such as a digital still camera and a digital cassette video, it is advantageous to make a DC level of output signals of an audio signal amplifier and a video signal amplifier at a ground level (zero volt) because a capacitor for removing a DC component at the output terminals can be eliminated, thus miniaturizing the equipment and reducing the number of components. In order to make a DC level of the output signals at zero volt, both positive and negative voltages are required as a power supply voltage for the audio signal amplifier and the video signal amplifier. JP H11(1999)-122050A describes an amplifier circuit in which a power supply voltage fed to a power amplifier for amplifying audio signals is switched between positive and negative power supply voltages +Vcc and −Vcc.

Instead of supplying both of the positive and the negative power supply voltages to a semiconductor integrated circuit including an audio signal amplifier and a video signal amplifier, only a positive power supply voltage may be supplied, and a negative power supply voltage may be generated inside the semiconductor integrated circuit from the positive power supply voltage. Such a configuration is preferable because the power supply circuit can be simplified. In this case, the semiconductor integrated circuit has to include a negative voltage generation circuit such as a charge pump circuit therewithin. The charge pump circuit is well known as a circuit that uses a plurality of switching elements built in a semiconductor integrated circuit and a plurality of external capacitors to generate a double voltage or to generate a negative voltage from a positive voltage.

Furthermore, in the case of portable equipment in which miniaturization is important, an audio signal amplifier and a video signal amplifier are incorporated into a single semiconductor integrated circuit (single semiconductor chip or single package) for the purpose of reducing a footprint and the number of components. When a negative voltage generation circuit is built in a semiconductor integrated circuit in the above-stated manner, an external power supply circuit that supplies a power to the semiconductor integrated circuit simply can generate only a positive power supply voltage. Thus, the external power supply circuit can be simplified, which can contribute to the miniaturization of the equipment as a whole.

However, a negative voltage generation circuit built in a semiconductor integrated circuit has a small current-carrying capacity (i.e., a large internal resistance), and therefore the negative power supply voltage is prone to vary periodically along with the operation of a video signal amplifier. More specifically, a load current varies with a vertical period of the video signal (period of 60 Hz, called V rate), resulting in a fluctuation in the negative power supply voltage. This fluctuation in the negative power supply voltage adversely affects the audio signal amplifier, and an unusual sound is generated in some cases.

FIG. 10 schematically shows waveforms for explaining the problem occurring when an audio signal amplifier and a video signal amplifier are built in a single semiconductor integrated circuit. In FIG. 10, (a) shows an audio input signal XA, (b) shows a video input signal XV and (c) shows a variation in a negative power supply voltage. They schematically show that a fluctuation occurs in the negative power supply voltage in synchronization with the vertical period TV of the video input signal XV. In FIG. 10, (d) shows an audio output signal ZA, which schematically shows a periodic distortion (causing an unusual sound) occurring in the audio output signal ZA due to the periodic variation (fluctuation) of the negative power supply voltage. In FIG. 10, (e) shows a video output signal ZV, having a waveform obtained by amplifying the video input signal XV while keeping the original waveform.

In order to cope with such a problem, it can be considered to provide each of the audio signal amplifier and the video signal amplifier with a negative voltage generation circuit individually. Such a method, however, will lead to an increase in an area of the circuit inside the integrated circuit, which in turn will increase a chip area, as well as an increase in the number of external capacitors and an increase of the cost of the integrated circuit and equipment using it. Thus, such a method is not recommendable.

### SUMMARY OF THE INVENTION

Therefore, with the foregoing in mind, it is an object of the present invention to solve the above-stated problem with the simplest possible configuration. More specifically, it is an object of the present invention to provide a semiconductor integrated circuit including an audio signal amplifier and a video signal amplifier and capable of, with a simple additional circuit, suppressing adverse effects on an audio signal due to a fluctuation of a negative voltage occurring in synchronization with the vertical period of a video signal.

In order to attain the above-mentioned object, a semiconductor integrated circuit according to the first configuration of the present invention includes an audio signal amplifier and a video signal amplifier mounted on a single semiconductor chip, the audio signal amplifier and the video signal amplifier being configured to receive a supply of a positive power supply voltage and a negative power supply voltage. The semiconductor integrated circuit further includes: a negative voltage generation circuit that generates the negative power supply voltage and supplies the negative power supply voltage to the audio signal amplifier and the video signal amplifier; and a limit circuit that limits an amplitude of a signal input to the audio signal amplifier to a range free from an influence of a fluctuation in the negative power supply voltage supplied by the negative voltage generation circuit.

A semiconductor integrated circuit according to the second configuration of the present invention includes an audio signal amplifier and a video signal amplifier built in a single package, the audio signal amplifier and the video signal amplifier being configured to receive a supply of a positive power supply voltage and a negative power supply voltage. The semiconductor integrated circuit further includes: a negative voltage generation circuit that generates the negative power supply voltage and supplies the negative power supply voltage to the audio signal amplifier and the video signal amplifier; and a limit circuit that limits an amplitude of a signal input to the audio signal amplifier to a range free from an influence of a fluctuation in the negative power supply voltage supplied by the negative voltage generation circuit.

These and other advantages of the present invention will become apparent to those skilled in the art upon reading and understanding the following detailed description with reference to the accompanying figures.

### BRIEF DESCRIPTION OF THE DRAWINGS

FIG. 1 is a circuit block diagram of a semiconductor integrated circuit according to Embodiment 1 of the present invention.

FIG. 2 is a circuit diagram showing an exemplary configuration of a charge pump circuit included in the semiconductor integrated circuit.

FIG. 3 is a circuit block diagram of a semiconductor integrated circuit according to Embodiment 2 of the present invention.

FIG. 4 schematically illustrates waveforms showing the operation by the semiconductor integrated circuit.

FIG. 5 is a circuit diagram showing an exemplary configuration of a clipping circuit included in the semiconductor integrated circuit.

FIG. 6 illustrates waveforms showing the operation of the clipping circuit.

FIG. 7 is a circuit block diagram of a semiconductor integrated circuit according to Embodiment 3 of the present invention.

FIG. 8 schematically illustrates waveforms showing the operation of the semiconductor integrated circuit.

FIG. 9 is a circuit block diagram of a semiconductor integrated circuit according to Embodiment 4 of the present invention.

FIG. 10 schematically shows waveforms for explaining a problem occurring in the conventional configuration example in which an audio signal amplifier and a video signal amplifier are built in a single semiconductor integrated circuit.

### DETAILED DESCRIPTION OF THE INVENTION

In the semiconductor integrated circuit of the first configuration of the present invention, an audio signal amplifier and a video signal amplifier are mounted on a single semiconductor chip. In the semiconductor integrated circuit of the second configuration of the present invention, an audio signal amplifier and a video signal amplifier are built in a single package. Both of the first configuration and the second configuration have a limit circuit that limits an amplitude of a signal input to the audio signal amplifier to a range free from an influence of a fluctuation in the negative power supply voltage supplied by the negative voltage generation circuit.

With these configurations, the limit circuit can function so as to limit the amplitude of the signal input to the audio signal amplifier to a range so that the audio signal amplifier can operate linearly and output a signal without a distortion, even when there is a fluctuation in the negative power supply voltage supplied thereto from the negative voltage generation circuit. Thus, even when a fluctuation occurs in the negative power supply voltage in synchronization with the vertical period of the video signal, a distortion of the output signal of the audio signal amplifier due to the influence of the fluctuation can be suppressed, thus suppressing an unusual sound.

In the first or the second semiconductor integrated circuit of the present invention, the limit circuit used may be a clipping circuit that, when a signal with a peak value higher than a predetermined level is input, clips the peak value of the signal to the predetermined level and outputs the clipped signal.

Alternatively, the limit circuit used may be an AGC circuit having a function of controlling a gain automatically in accordance with an amplitude of an input signal.

Preferably, the limit circuit limits an amplitude of an input signal to be in a peak-to-peak symmetry.

Preferably, the limit circuit limits the amplitude of the signal input to the audio signal amplifier to an amplitude range smaller than a range where a fluctuation occurs in the negative power supply voltage resulting from a vertical synchronous signal of a video signal input to the video signal amplifier.

The following describes embodiments of the present invention, with reference to the drawings.

### EMBODIMENT 1

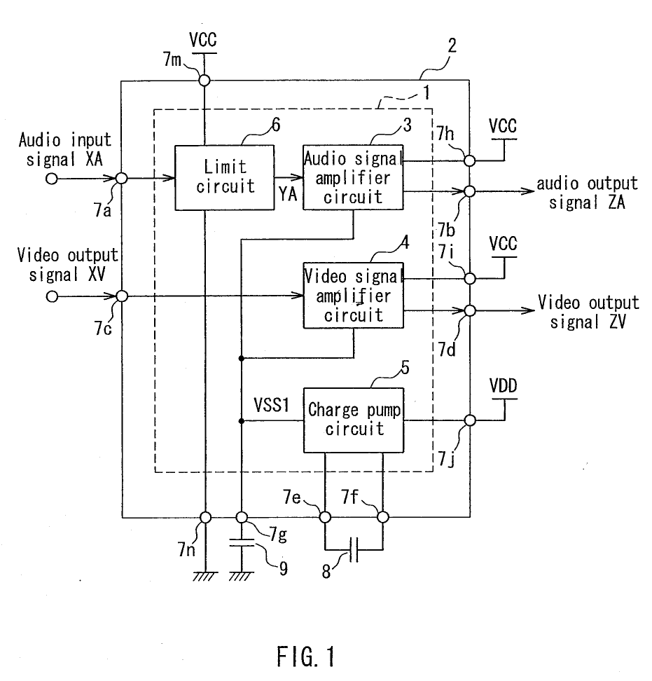

FIG. 1 is a circuit block diagram of a semiconductor integrated circuit according to Embodiment 1 of the present invention. This semiconductor integrated circuit 1 is integrated on a single semiconductor chip 2. The semiconductor integrated circuit 1 is for processing an audio signal and a video signal, which includes an audio signal amplifier circuit 3, a video signal amplifier circuit 4, a charge pump circuit 5 and a limit circuit 6 within it.

An audio input signal XA input through a pad 7a formed on the semiconductor chip 2 is input to the limit circuit 6, and an output signal YA therefrom is input to the audio signal amplifier circuit 3. An output signal from the audio signal amplifier circuit 3 is output through a pad 7b on the semiconductor chip 2 as an audio output signal ZA.

A video input signal XV input through a pad 7c on the semiconductor chip 2 is input directly to the video signal amplifier circuit 4, and an output signal therefrom is output through a pad 7d on the semiconductor chip 2 as a video output signal ZV.

The charge pump circuit 5 is configured as a negative voltage generation circuit to generate a negative power supply voltage. A flying capacitor 8 and an external storage capacitor 9 are connected externally with the charge pump circuit 5, which are provided outside the semiconductor chip 2 via pads 7e, 7f and 7g. A negative power supply voltage VSS1 generated by the charge pump circuit 5 with which the flying capacitor 8 and the external storage capacitor 9 are connected is supplied to the audio signal amplifier circuit 3 and the video signal amplifier circuit 4.

In addition to the above-stated negative power supply voltage VSS1, a positive power supply voltage VCC also is supplied to the audio signal amplifier circuit 3 and the video signal amplifier circuit 4. This positive power supply voltage VCC is supplied from an external power supply circuit (not illustrated) outside the semiconductor chip 2 via pads 7h and 7i. A positive power supply voltage VDD is supplied externally to the charge pump circuit 5 via a pad 7j. The limit circuit 6 is fed externally with the positive power supply voltage VCC via a pad 7m, and is grounded via a pad 7n.

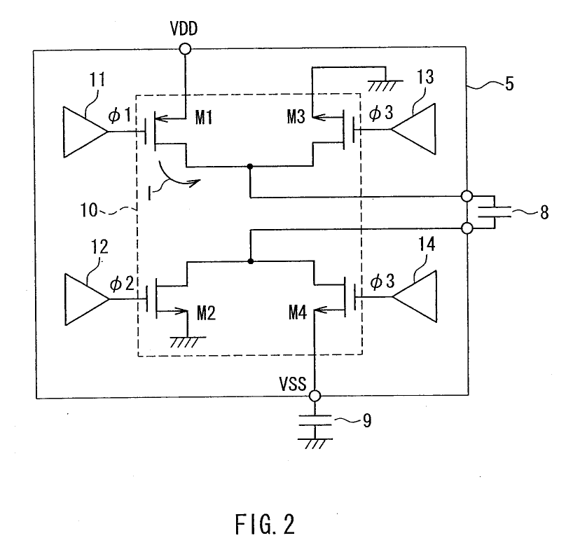

FIG. 2 shows a specific configuration example of the charge pump circuit 5. This charge pump circuit 5 is a well-known circuit, which includes a charge pump output stage 10 and gate driving drivers 11 to 14. A flying capacitor 8 and an external storage capacitor 9 are similar to those of FIG. 1.

The charge pump output stage 10 is composed of a PMOS transistor M1, a NMOS transistor M2, a NMOS transistor M3 and a NMOS transistor M4. A drain and a source of the transistor M1 are connected with a plus terminal of the flying capacitor 8 and VDD, respectively. A drain and a source of the transistor M2 are connected with a minus terminal of the flying capacitor 8 and GND, respectively. A drain and a source of the transistor M3 are connected with the plus terminal of the flying capacitor 8 and GND, respectively. A drain and a source of the transistor M4 are connected with the minus terminal of the flying capacitor 8 and the external storage capacitor 9, respectively. The gate drivers 11 to 14 respectively supply signals φ 1 to φ 3 to the gates of the transistors M1, M2, M3 and M4.

This charge pump circuit 5 operates as follows. While φ 3 is at L level, when φ 1 and φ 2 respectively are shifted from H level to L level and from L level to H level at the same time, the transistors M1 and M2 turn ON while the transistors M3 and M4 are OFF. Thereby, a charging current I flows from VDD through the flying capacitor 8 to start the charging of the flying capacitor 8. Next, when φ 1 and φ 2 respectively are shifted to H level and L level and subsequently φ 3 is shifted from L level to H level, then the transistors M1 and M2 turn OFF, while the transistors M3 and M4 turn ON. Thereby, the electrical charge accumulated in the flying capacitor 8 is transferred to the external storage capacitor 9 in accordance with the charge conservation principle. As φ 1, φ 2 and φ 3 are shifted in a similar manner, VSS finally is charged to −VDD.

In the above-stated configuration, it is difficult to reduce an internal impedance of the charge pump circuit 5 because of a circuit arrangement, and the negative power supply voltage VSS1 is prone to vary in accordance with a variation of the load current. Furthermore, an operating current of the video signal amplifier circuit 4 in the semiconductor integrated circuit 1 varies with the period of 60 Hz (vertical period) that is the V rate of the video signal. As a result, a fluctuation occurs in the negative power supply voltage VSS1 in synchronization with the vertical period. Such a negative power supply voltage VSS1 is supplied to the audio signal amplifier circuit 3 as well, where the fluctuation adversely affects the operation of the audio signal amplifier circuit 3, and an unusual sound is generated in some cases.

According to the semiconductor integrated circuit of the present embodiment, however, a signal passing through the limit circuit 6 is supplied to the audio signal amplifier circuit 3 as the input signal YA. Herein, the limit circuit 6 functions so as to limit the amplitude of the input signal YA of the audio signal amplifier circuit 3 within a range free from the influence of the fluctuation in the negative power supply voltage supplied from the charge pump circuit 5. As a result, the audio output signal ZA has a waveform with a limitation at positive and negative predetermined levels, thus suppressing an unusual sound.

The above-mentioned range that is free from the influence of the fluctuation in the negative power supply voltage may be defined practically as a range with a smaller amplitude than the range where a fluctuation occurs in a negative power supply voltage due to a vertical synchronous signal of a video signal input to the video signal amplifier circuit 4. The limit circuit 6 may limit the amplitude of the signal input to the audio signal amplifier circuit 3 within such a range.

### EMBODIMENT 2

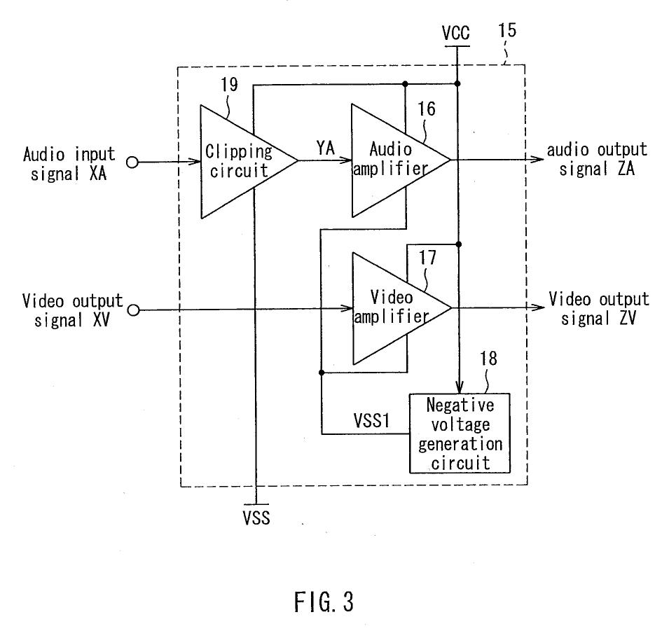

FIG. 3 is a circuit block diagram of a semiconductor integrated circuit according to Embodiment 2 of the present invention. This semiconductor integrated circuit 15 is for processing an audio signal and a video signal similar to Embodiment 1, and includes an audio amplifier 16, a video amplifier 17, a negative voltage generation circuit 18 and a clipping circuit 19 within it. In this semiconductor integrated circuit 15, the audio amplifier 16 corresponds to the audio signal amplifier circuit 3 of Embodiment 1. Similarly, the video amplifier 17, the negative voltage generation circuit 18 and the clipping circuit 19 correspond to the video signal amplifier circuit 4, the charge pump circuit 5 and the limit circuit 6, respectively.

The semiconductor integrated circuit 15 operates in a similar manner to the semiconductor integrated circuit 1 of Embodiment 1. Herein, the clipping circuit 19 is an element embodying the limit circuit 6. When a signal with a peak value higher than a predetermined level is input to the clipping circuit 19, the clipping circuit 19 clips the peak value of the input signal to the predetermined level and outputs the same. In other words, the clipping circuit 19 functions as a limit circuit that limits the amplitude of the input signal of the audio amplifier 16 within a range free from the influence of the fluctuation in the negative power supply voltage supplied from the negative voltage generation circuit 18. As a result, the audio output signal ZA has a waveform with a limitation at positive and negative predetermined levels, thus suppressing an unusual sound.

It should be noted here that the linear operation range of the audio amplifier 16 free from a distortion of a signal is determined by the positive and negative power supply voltages VCC and VSS1 and the amplitude of the input signal. Even when the negative power supply voltage VSS1 fluctuates so as to narrow the linear operation range of the audio amplifier 16, the generation of distortion can be suppressed by limiting the amplitude of the input signal to a linear operation range.

Such a range of the input signal for suppressing distortion due to the generation of a fluctuation of the power supply can be predicted beforehand when the semiconductor integrated circuit is designed. Then, it is possible to configure the semiconductor integrated circuit of the present embodiment so as to permit the limiting function to operate only when the video circuit is operated.

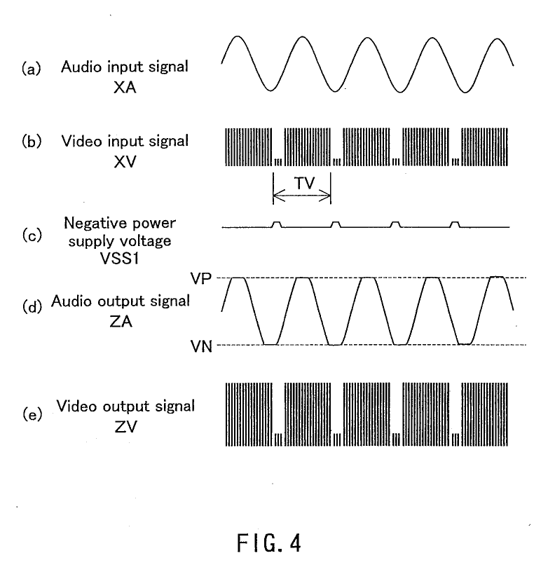

FIG. 4 schematically illustrates waveforms showing the operation by the semiconductor integrated circuit according to the present embodiment. In FIG. 4, (a) shows an audio input signal XA, (b) shows a video input signal XV and (c) shows a fluctuation in a negative power supply voltage VSS1, which schematically shows that the fluctuation occurs in the negative power supply voltage VSS1 in synchronization with the vertical period TV of the video input signal XV. In FIG. 4, (d) shows an audio output signal ZA. As described above, the audio output signal ZA has a waveform with a limitation at each of the positive clipping level VP and the negative clipping level VN because of the function of the clipping circuit 19, thus suppressing an unusual sound. In FIG. 4, (e) shows a video output signal ZV having a waveform obtained by amplifying the video input signal XV while keeping the original waveform.

Exemplary numerical values of these waveforms follow. The audio output signal ZA of (d) is 4 to 5 V. The positive power supply voltage VCC is 3 V, and the negative power supply voltage VSS1 is −2.5 V. The fluctuation in the negative power supply voltage VSS1 resulting from the vertical signal of the video input signal XV is about 100 mV. The limitation on the audio input signal XA by the clipping circuit 19 may be 0.7 V for both of the positive and negative sides, whereby sufficient effects can be obtained.

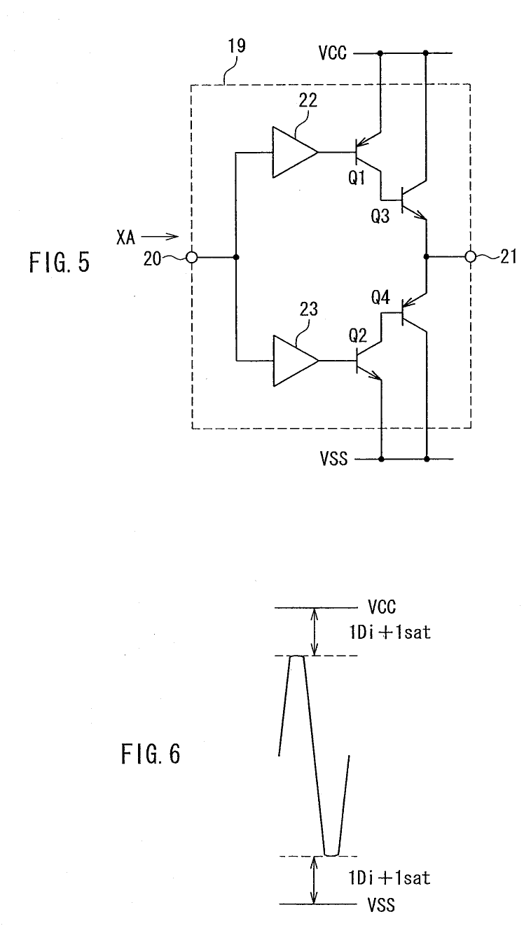

FIG. 5 shows a specific configuration example of the clipping circuit 19. The audio input signal XA is input from an input terminal 20, and an output signal from an output terminal 21 is supplied to the audio amplifier 16. The audio input signal XA passes through drivers 22 and 23, and is output from a push-pull type output stage composed of transistors Q1 to Q4. Thereby, the output signal is limited within a range between (VCC-(1Di+1Sat)) and (VSS+(1Di+1Sat)) as shown in FIG. 6.

It should be noted here that the negative power supply voltage VSS used in the clipping circuit 19 may be at a ground level (zero volt). In such a case, a level shift circuit has to be inserted between the output terminal of the clipping circuit 19 and the input terminal of the audio amplifier 16 for the matching of a DC level.

### EMBODIMENT 3

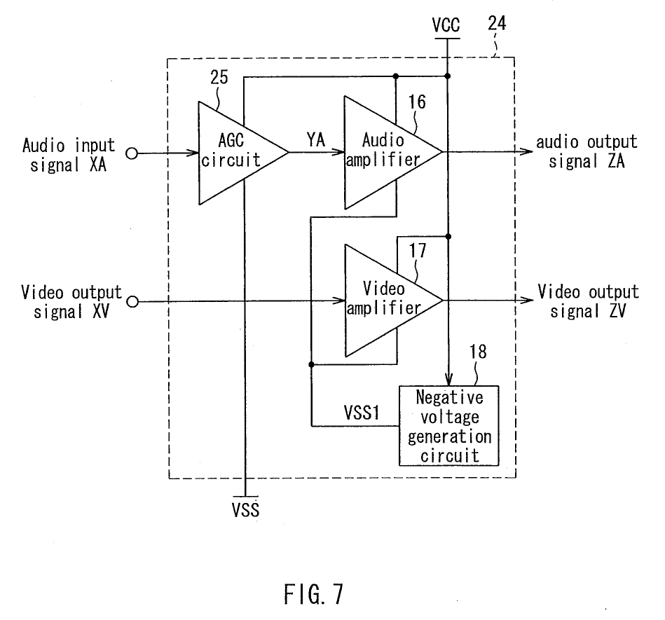

FIG. 7 is a circuit block diagram of a semiconductor integrated circuit according to Embodiment 3 of the present invention. A semiconductor integrated circuit 24 of the present embodiment has a configuration in which the clipping circuit 19 of the semiconductor integrated circuit 15 of Embodiment 2 is replaced with an AGC circuit 25. The AGC circuit 25 has a function of controlling a gain automatically in accordance with the amplitude of an input signal. Therefore, the AGC circuit 25 functions as a limit circuit that limits the amplitude of the input signal of the audio amplifier 16 within a range free from the influence of the fluctuation in a negative power supply voltage supplied from a negative voltage generation circuit 18. In the semiconductor integrated circuit 24 of the present embodiment, an audio input signal XA is input to the AGC circuit 25, and an output signal YA therefrom is input to an audio amplifier 16. An output signal of the audio amplifier 16 is output externally from the semiconductor integrated circuit 24 as an audio output signal ZA.

In the semiconductor integrated circuit 24 of the present embodiment also, the effects of suppressing the influence of the fluctuation in the negative power supply voltage VSS1 supplied to the audio amplifier 16 from the negative voltage generation circuit 18 can be obtained, thus suppressing an unusual sound. That is to say, when a signal at a predetermined level or higher is input, the AGC function of the AGC circuit 25 is effected so that the audio output signal ZA can be suppressed within a predetermined output level, thus suppressing an unusual sound resulting from the fluctuation in the negative power supply voltage VSS1.

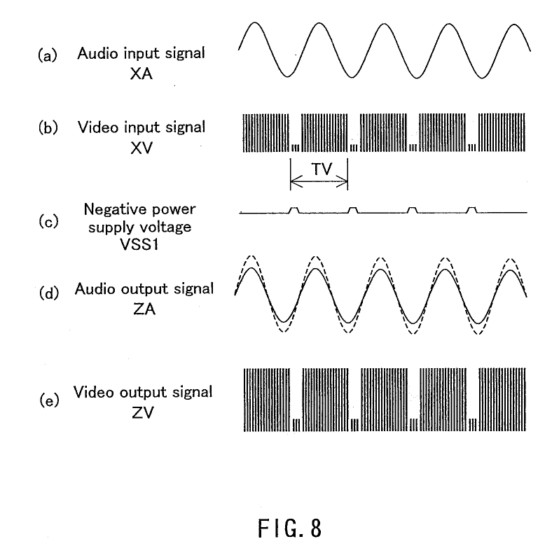

FIG. 8 schematically illustrates waveforms showing the operation by the semiconductor integrated circuit according to the present embodiment. In FIG. 8, (a) shows an audio input signal XA, (b) shows a video input signal XV and (c) shows a fluctuation in a negative power supply voltage VSS1, which schematically shows that the fluctuation occurs in the negative power supply voltage VSS1 in synchronization with the vertical period TV of the video input signal XV. In FIG. 8, (d) shows an audio output signal ZA. As described above, even when the amplitude of the audio output signal ZA has a tendency of increasing as shown in the dashed lines, the AGC circuit 25 functions so as to suppress the amplitude as shown in the solid line, thus suppressing an unusual sound. In FIG. 8, (e) shows a video output signal ZV having a waveform obtained by amplifying the video input signal XV while keeping the original waveform.

### EMBODIMENT 4

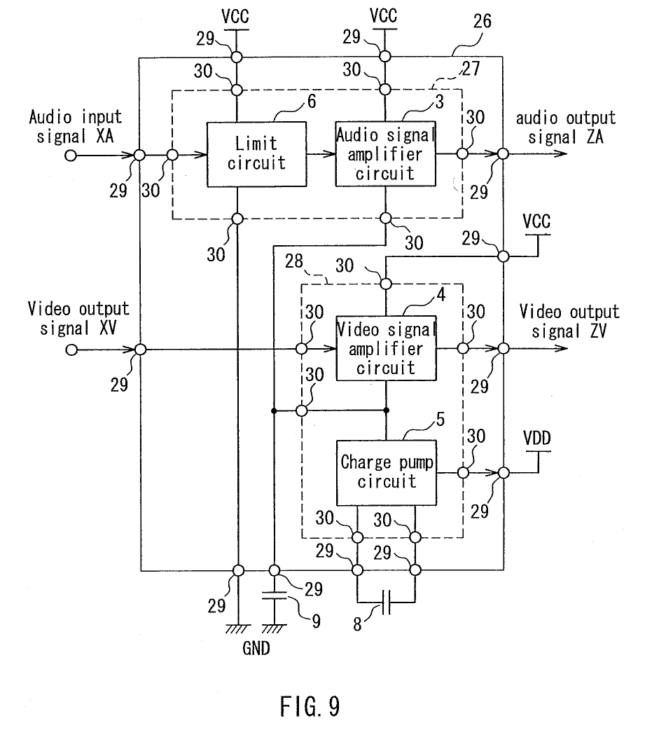

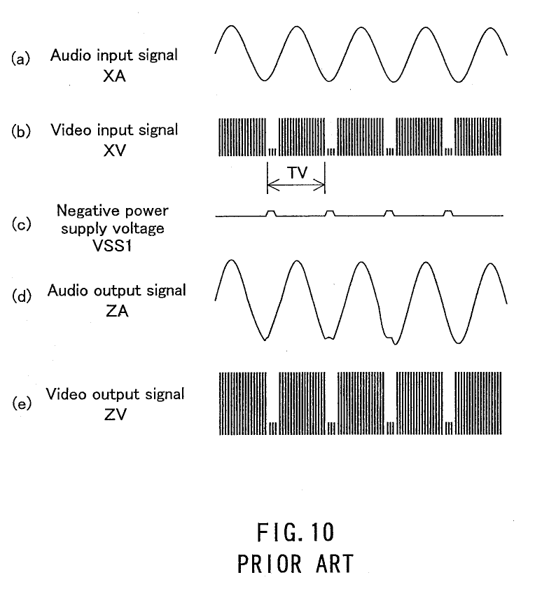

FIG. 9 is a circuit block diagram of a semiconductor integrated circuit according to Embodiment 4 of the present invention. The semiconductor integrated circuit of the present embodiment is composed of a plurality of (two) semiconductor chips built in a single package 26. A first semiconductor chip 27 has an audio signal processing circuit mounted thereon including a limit circuit 6 and an audio signal amplifier circuit 3. A second semiconductor chip 28 includes a video signal amplifier circuit 4 (video signal processing circuit) and a charge pump circuit 5 mounted thereon. External connection pins 29 of the package 26 and pads 30 formed on the semiconductor chips 27 and 28 are connected electrically. The specific configuration of the individual circuits may be similar to that in the semiconductor integrated circuit 15 or 24 of Embodiment 2 or 3.

An audio input signal XA input from the external connection pin 29 is input to the limit circuit 6 via the pad 30 on the semiconductor chip 27, and an output signal therefrom is input to the audio signal amplifier circuit 3. An output signal of the audio signal amplifier circuit 3 is output from the external connection pin 29 of the package 26 via the pad 30 on the semiconductor chip 27 as an audio output signal ZA.

A video input signal XV input from the external connection pin 29 is input to the video signal amplifier circuit 4 via the pad 30 on the semiconductor chip 28, and an output signal therefrom is output from the external connection pin 29 of the package 26 via the pad 30 on the semiconductor chip 28 as a video output signal ZV.

The charge pump circuit 5 is provided on the semiconductor chip 28, which is for generating a negative power supply voltage. A negative power supply voltage generated by the charge pump circuit 5, a flying capacitor 8 and an external storage capacitor 9 is supplied to the audio signal amplifier circuit 3 on the semiconductor chip 27 and the video signal amplifier circuit 4 on the semiconductor chip 28.

According to the semiconductor integrated circuit of the present embodiment, the limit circuit 6 corresponding to the clipping circuit 19 of Embodiment 2 or the AGC circuit 25 of Embodiment 3 functions so as to suppress the influence of the fluctuation in the negative power supply voltage supplied to the audio signal amplifier circuit 3, thus suppressing an unusual sound.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A semiconductor integrated circuit, comprising an audio signal amplifier and a video signal amplifier mounted on a single semiconductor chip, the audio signal amplifier and the video signal amplifier being configured to receive a supply of a positive power supply voltage and a negative power supply voltage,
wherein the semiconductor integrated circuit further comprises:
a negative voltage generation circuit that generates the negative power supply voltage and supplies the negative power supply voltage to the audio signal amplifier and the video signal amplifier; and
a limit circuit that limits an amplitude of a signal input to the audio signal amplifier to a range free from an influence of a fluctuation in the negative power supply voltage supplied by the negative voltage generation circuit.

2. The semiconductor integrated circuit according to claim 1, wherein the limit circuit is a clipping circuit that, when a signal with a peak value higher than a predetermined level is input, clips the peak value of the signal to the predetermined level and outputs the clipped signal.

3. The semiconductor integrated circuit according to claim 1, wherein the limit circuit is an AGC circuit having a function of controlling a gain automatically in accordance with an amplitude of an input signal.

4. The semiconductor integrated circuit according to claim 1, wherein the limit circuit limits an amplitude of an input signal to be in a peak-to-peak symmetry.

5. The semiconductor integrated circuit according to claim 1, wherein the limit circuit limits the amplitude of the signal input to the audio signal amplifier to an amplitude range smaller than a range where a fluctuation occurs in the negative power supply voltage resulting from a vertical synchronous signal of a video signal input to the video signal amplifier.

6. A semiconductor integrated circuit, comprising an audio signal amplifier and a video signal amplifier built in a single package, the audio signal amplifier and the video signal amplifier being configured to receive a supply of a positive power supply voltage and a negative power supply voltage,
wherein the semiconductor integrated circuit further comprises:
a negative voltage generation circuit that generates the negative power supply voltage and supplies the negative power supply voltage to the audio signal amplifier and the video signal amplifier; and
a limit circuit that limits an amplitude of a signal input to the audio signal amplifier to a range free from an influence of a fluctuation in the negative power supply voltage supplied by the negative voltage generation circuit.

7. The semiconductor integrated circuit according to claim 6, wherein the limit circuit is a clipping circuit that, when a signal with a peak value higher than a predetermined level is input, clips the peak value of the signal to the predetermined level and outputs the clipped signal.

8. The semiconductor integrated circuit according to claim 6, wherein the limit circuit is an AGC circuit having a function of controlling a gain automatically in accordance with an amplitude of an input signal.

9. The semiconductor integrated circuit according to claim 6, wherein the limit circuit limits an amplitude of an input signal to be in a peak-to-peak symmetry.

10. The semiconductor integrated circuit according to claim 6, wherein the limit circuit limits the amplitude of the signal input to the audio signal amplifier to an amplitude range smaller than a range where a fluctuation occurs in the negative power supply voltage resulting from a vertical synchronous signal of a video signal input to the video signal amplifier.
